(19) United States
(12) Patent Application Publication
(10) Pub. No.: US 2008/0239099 A1
(43) Pub. Date: Oct. 2, 2008

(54) CAMERA

(75) Inventor: Nobuaki ABE, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 12/057,549

(22) Filed: Mar. 28, 2008

(30) Foreign Application Priority Data
Mar. 30, 2007 (JP) 2007-091160

(51) Int. Cl. H04N 5/76; H04N 5/217

(52) U.S. Cl. 348/231.99; 348/241; 348/E05.078

(57) ABSTRACT

A camera according has an interchangeable lens unit removably attached to a camera body, and an image-generating processor that generates image data of a subject captured by the lens unit. A memory provided in the lens unit stores distortion data. The distortion data is associated with an approximation function, which represents the correspondence relationship between image height and distortion aberration. The distortion data includes at least one of: coefficient data of the approximation function, and sample data of the image height and the corresponding distortion aberration. Furthermore, the camera has an approximation function processor that defines an approximation function used to process the image data on the basis of the distortion data read from the memory, and a distortion correction processor that carries out distortion correction processing on the image data based on the aberration distortion calculated for each image point by the defined approximation function.

### BACKGROUND OF THE INVENTION

1. Field of the Invention

The present invention relates to a camera with an interchangeable lens, such as an SLR (Single Lens Reflex) camera. In particular, it relates to a camera with a distortion-correction function.

2. Description of the Related Art

In a camera, image distortion occurs in a picture due to the characteristics of an optical lens. Distortion aberration varies with the lens's position along the optical axis. For example, the distortion aberration at a telephoto angle is different from that at a wide angle. In a digital camera, image distortion can be corrected by the image correction process, wherein the coordinate information of image points, i.e., individual pixels, is modified by utilizing aberration data measured in advance. For example, the distortion correction process is carried out within the focal mange of a zoom (telephoto) lens that produces a large degree of distortion. Also, an image may be divided into a plurality of minute areas, and the distortion correction process may be performed on each minute area.

The characteristics of image distortion vary with a target object's distance, the focal length, and so on. Consequently, the amount of distortion aberration data necessary for correcting the distortion becomes excessively large. In particular, in the case of a camera equipped with an interchangeable lens unit, ouch as an SLR-type camera, distortion aberration data must be prepared for attachable lenses at all focal lengths, resulting in a further increase in the distortion aberration data that must be stored.

### SUMMARY OF THE INVENTION

An object of the present invention is to provide a camera, apparatus, and method for correcting distortion, and a computer program that is capable of correcting image distortion accurately while restricting the amount of data necessary for distortion correction.

A camera according to the present invention has an interchangeable lens unit removably attached to a camera body, and an image generating processor that generates image data of a subject captured by the lens unit. A memory provided in the lone unit stores distortion data. The distortion data is associated with an approximation function, which represents a correspondence relationship between image height and distortion aberration. Then, the distortion data includes at least one of, coefficient data of the approximation function, and sample data of the image height and the corresponding distortion aberration.

In the present invention, the camera has an approximation function processor, and a distortion correction processor. The approximation function processor defines an approximation function used for the generated image data on the basis of the distortion data read from the memory. The distortion correction processor carries out a distortion correction process on the image data based on the distortion aberration of each image point which is calculated by the defined approximation function.

An apparatus for correcting image distortion, according to another aspect of the present invention, has: a data-reading processor that reads distortion data from a memory provided in the lens unit; an approximation function processor that defines an approximation function used for an object image captured by an interchangeable lens, on the basis of the distortion data; a distortion aberration calculator that calculates the distortion aberration of each image point using the defined approximation function; and a distortion correction processor that carries out distortion correction processing on the image data on the basis of the calculated distortion aberrations.

A computer-readable medium that stores a program for correcting image distortion, according to another aspect of the present invention, has a data-reading process code segment that reads distortion data from a memory provided in an interchangeable lens unit, an approximation function process code segment that defines an approximation function used for an object image, formed by the interchangeable lens unit, on the basis of the distortion data; a distortion aberration calculation coda segment that calculates a distortion aberration of each image point by the defined approximation function; and a distortion correction process code segment that carries out a distortion correction process to the image data on the basis of the calculated distortion aberrations.

A method for correcting image distortion, according to another aspect of the present invention, includes: a) reading distortion data from a memory provided in an interchangeable lens unit; b) defining an approximation function used for an object image captured by the interchangeable lens unit, on the basis of the distortion data, c) calculating the distortion aberration of each image point using the defined approximation function; and d) carrying out distortion correction processing on the image data on the basis of the calculated distortion aberration.

### BRIEF DESCRIPTION OF THE DRAWINGS

The present invention will be better understood from the description of the preferred embodiments of the invention set forth below together with the accompanying drawings, in which:

FIG. 1 is schematic perspective view of a digital camera according to a first embodiment;

FIG. 2 is a block diagram of the digital camera according to the first embodiment;

FIG. 3 is a view illustrating the distortion aberration characteristics of the photographic optical system;

FIG. 4 is a view showing the distortion aberration obtained by an approximation calculation;

FIG. 5 is a view showing the percentage error of the approximation functions as determined by formulae;

FIG. 6 is view showing the distortion aberration calculated by the 3^{rd}-degree approximation sine function according to the formula;

FIG. 7 is a flowchart of the distortion correction process performed by the system control circuit;

FIGS. 8A to 8C are views showing a correction of image distortion;

FIG. 9 is a view showing plot of image height versus distortion aberration, and a linear approximation function, according to the second embodiment;

FIG. 10 is a view showing a graph or errors produced by the linear approximation function;

FIG. 11 is a view showing a plot of image heights versus distortion aberrations together with a 6^{th}-degree approximation polynomial, according to the third embodiment;

FIG. 12 is a view showing a graph of a 6^{th}-degree approximation function together with a linear approximation function, according to the fourth embodiment; and

FIG. 13 is a view showing a graph of an approximation sine function and a linear approximation function, according to the fifth embodiment.

### DESCRIPTION OF THE PREFERRED EMBODIMENTS

Hereinafter, the preferred embodiments of the present invention are described with reference to the attached drawings.

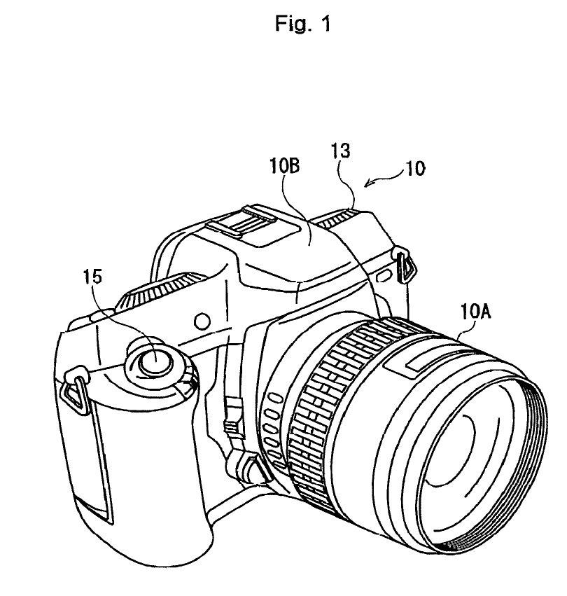

FIG. 1 is a schematic perspective view of a digital camera according to a first embodiment.

An SLR-type digital camera 10 is equipped with an interchangeable lens unit 10A, which is removably attached to a camera body 10B. A release button 15 is operated by the user to take a picture, and a mode dial 13 is operated to set picture mode or playback mode. In the lens unit 10A, a photographic optical system (not shown) with a zoom lens is provided. Zooming can be performed in AF (Auto Focus) mode or MF (Manual Focus) mode.

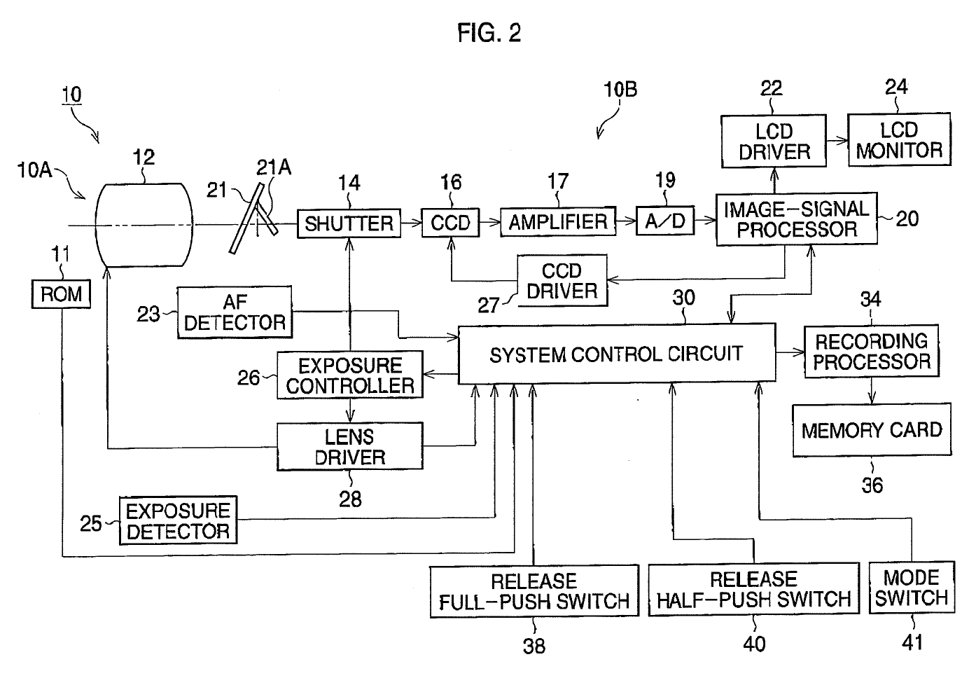

FIG. 2 is a block diagram of the digital camera 10 according to the present embodiment.

The digital camera 10 is equipped with an image-signal processor 20 and a system control circuit 30, and a memory card 36 is removably installed in the camera body 10B. The system control circuit 30, including a CPU, a ROM unit and a RAM unit, connects with a release full-push switch 38, a release half-push switch 40, and a mode switch 41. The system control circuit 30 detects an operation signal when the mode dial 13 or the release button 15 is operated by the user. A program for controlling camera operations is stored in the ROM of the system control circuit 30. When the electrical power button (not shown) is turned on, a picture mode that allows the user to take a picture is set.

In the picture mode, light passing through a photographic optical system 12, reaches a quick-return mirror 21, and is reflected toward a pentagonal prism (not shown). Thus, a target subject is viewed via a viewfinder (not shown) provided on the back surface or the cameras body 10R. Also, the light is directed to a focus detector 23 by a sub-mirror 21A provided behind the quick-return mirror 21.

When the release button 15 is depressed halfway, the brightness of the object is detected by an exposure detector 25. Then, exposure values, i.e., shutter speed and F number (aperture value) are calculated. At the same time, a series of focusing lenses, provided in the photographic optical system 12, are driven by a lens driver 29 to focus the object image formed by the photographic optical system 12. Herein, the phase-difference detecting method is applied for an AF adjustment process. Namely, a focus adjustment process is carried out on the basis of a pair of photodetectors in the focus detector 22

When the release button 15 is fully depressed, the is photographing operation is carried out. Namely, the quick-return mirror 21 moves outside the light path, and a shutter 14 opens for a given period in accordance with a control signal fed from an exposure controller 26. Thus, an object image is formed on a CCD 16, and one-frame's worth of analog image pixel signals is generated. The image-pixel signals are read from the CCD 16 by driving signals fed from a CCD driver 27.

The image-pixel signals are amplified by an amplifier 17 and converted to digital image signals. Various processes, such as white balance adjustment, gamma correction, and so on, are carried out on the digital image signals in the image-signal processor 20 in order to generate the image data. The image data is temporarily stored in a frame memory (not shown), and is transmitted to the system control circuit 30.

As described below, the image data is subjected to a distortion correction process in the system control circuit 30 to correct for image distortion due to the optical photographic system 12. The distortion-corrected image data is compressed using a known method (e.g., JPEG method) in the recording processor 34, and is recorded on the memory card 36.

When playback mode is set, a playback process is carried out. Namely, the compressed image data is read from the memory card 36, and is expanded in the recording processor 34. The reconstructed image data is fed to an LCD driver 22 via the system control circuit 30 and the image-signal processor 20. The LCD driver 22 drives an LCD monitor 24 so that the recorded image is displayed on the LCD monitor 24.

Distortion data, associated with image distortion due to the photographic optical system 12, is stored in a ROM 11 provided in the lens unit 10A. When the lens unit 10A is attached to the camera body 10B, the connection is detected by pins (not shown) provided at a connecting portion of the camera body 10B, and the distortion data in the ROM 11 is fed to the system control circuit 30. The system control circuit 30 calculates distortion aberrations over the entirety of the images on the basis of the data, and carries out the distortion correction process.

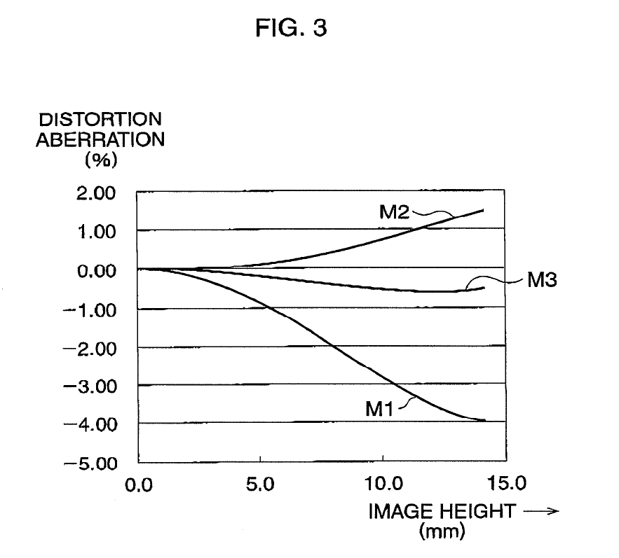

FIG. 3 is a view illustrating characteristics of distortion aberration. Next, an approximation calculation for obtaining a distortion aberration is explained.

In FIG. 3, a graph of distortion aberration caused by the optical photographic system 12 is shown. The abscissa indicates the image height, representing the distance from the image center point, and the ordinate indicates the value of the corresponding distortion aberration. The distortion aberration D(%) represents the ratio of the difference between the actual image height y′ and the ideal image height y, to the ideal image height y.

The value or the distortion aberration D (=100×(y−y′)y)) varies with focal length. In FIG. 3, three plot lines of the distortion aberration D, corresponding to three focal lengths, are shown. Note that the actual image height y′ in largely constant in all radial directions. Namely, when a focal length is chosen, the actual image height y′ as shown in FIG. 3 is determined without regard to radial direction.

In FIG. 3, the distortion aberration for a wide angle focal length is represented by curve M1, distortion aberration for a telephoto angle focal length is represented by curve M2, and distortion aberration for an intermediate focal length is represented by curve M3. The distortion aberration shown by curves M1, M2, and M3 correspond respectively to barrel distortion, pincushion distortion, and mustache distortion.

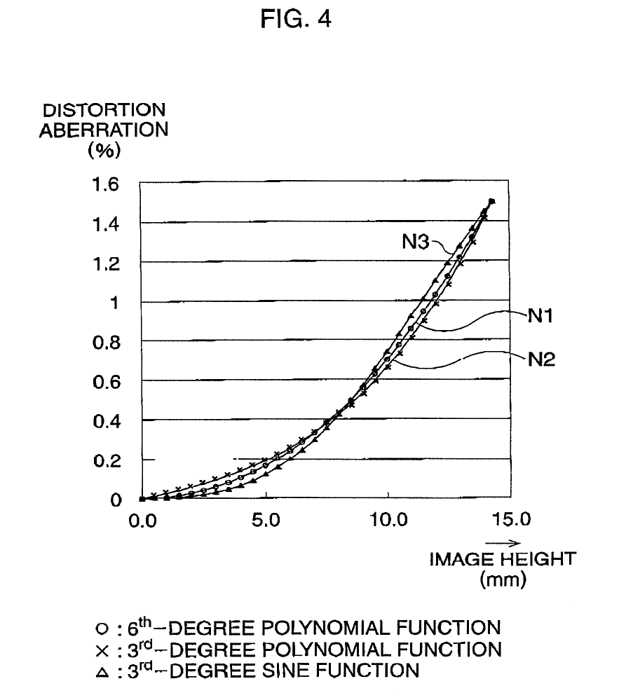

FIG. 4 is a view showing the distortion aberration obtained by an approximation calculation. Herein, the distortion aberration associated with line M2 shown in FIG. 3 (corresponding to pincushion distortion) is shown. Note that the scale of the distortion aberration in FIG. 4 differs from that of FIG. 3.

The distortion aberration curve M2, which is defined by plotting values of distortion aberrations, can be represented by an approximation function. A curve of the distortion aberration is generated by one of the following formulae.

$$\begin{matrix}D = a {y}^{6} + b {y}^{5} + c {y}^{4} + d {y}^{3} + e {y}^{2} + f y + g & ( 1 ) \\ D = k {y}^{3} + l y & ( 2 ) \\ D = s {sin}^{3} ( \frac{y}{t} ) & ( 3 )\end{matrix}$$

Formula (1) represents a 6^{th}-degree approximation polynomial. Six coefficients (a to g) are defined. Formula (2) is a 3^{rd}-degree approximation polynomial, which is composed of a term to the third power and a term to the first power. Two coefficients (k, 1) are also defined. Finally, formula (3) is a 3^{rd}-degree since function, defined by its third-power sine function and the term associated with an angle. Two coefficients, s and t, are defined. In FIG. 4, the three functions of the formulas (1) to (3) are represented by curves N1, N2, and N3, respectively.

The coefficients of each approximation function vary with focal length. In the present embodiment, 4 series of coefficient data, which is defined for each focal length, is stored in the ROM 11 of the lens unit 10A, and it is read from the ROM 11 when the lens unit 10A is attached to the camera body 10B, and then the coefficient data is stored in the RAM of the system control circuit 30. Coefficients of the curves shown in FIG. 4 (corresponding to a telephoto angle focal length) are as follows.

a=−4.045×10⁻⁹

b=1.843×10⁻⁷

c=1.322×10⁻⁶

d=1.254×10⁻⁵

e=6.558×10³

f=1.154×10⁻⁴

g=2.214×10⁻⁴ (4)

k=3.8×10⁻⁴

l=2.8×10⁻² (5)

s=1.97

t12.4 (6)

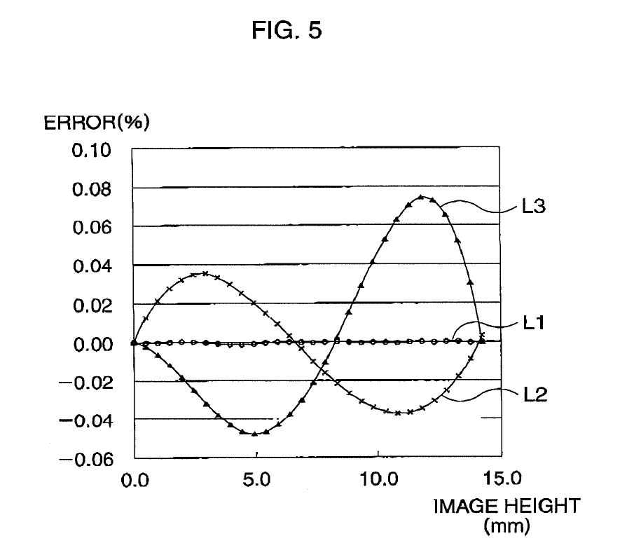

FIG. 5 is a graph showing the errors (t) of the approximation functions given by formulae (1) to (3).

In FIG. 5, the error between the actual measured distortion aberration and the distortion aberration calculated by the above approximation equations (1) to (3) is shown with respect to a plurality of image heights. The errors produced by the 6^{th}- and 3^{rd}-degrae approximation polynomials, and by the 3″-degree sine function are represented by curves L1, L2, and L3, which are defined by joining error plots. As can be seen from FIG. 5, the error by the 6^{th}-degree approximation polynomial is nearly zero. Also, the error produced by the 3^{rd}-degree approximation polynomial and the 3^{rd}-degree approximation sine function do not exceed 0.08%. In general, an error within 2.00 does not cause problems for the distortion correction process. Therefore, by using the formulae (1) to (3), highly realistic distortion aberration values may be obtained.

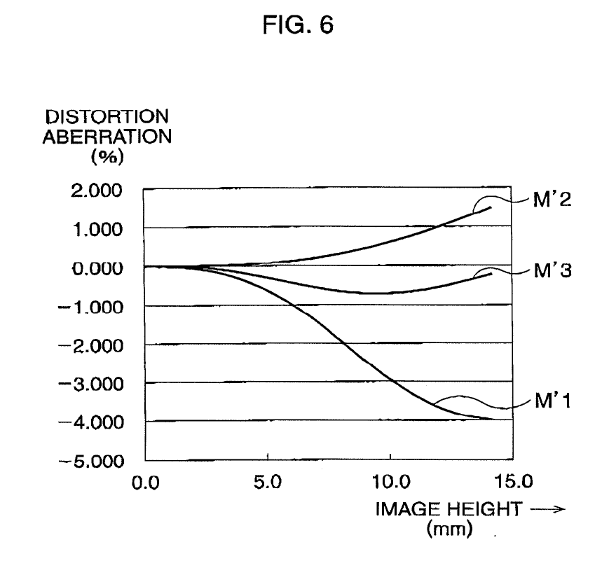

FIG. 6 is a graph showing the distortion abbreviation calculated by the 3^{rd}-degree approximation sine function according to the formulae (3).

In FIG. 6, three 3^{rd}-degree approximation sine functions are shown. The distortion aberration represented by curve M′1 is based on a wide angle focal length, the distortion aberration represented by curve M′2 is based on a telephoto angle focal length, and the distortion aberration represented by curve M′3 is based on a focal length intermediate between wide and telephoto. The coefficients of the approximation sine functions are given in the following table. Note that the s₁ and t₁ are the coefficients of the approximation sine function based on barrel distortion, s₂ and t₂ are the coefficients of the approximation sine function based on pincushion distortion, and s₂ and t₃ are coefficients of the approximation sine function based on mustache distortion.

| | sᵢ | tᵢ | DISTORTION TYPE |
|---|---|---|---|
| i = 1 | 4 | 18 | BARREL |
| i = 2 | −4 | 9 | PINCUSHION |
| i = 3 | −0.7 | 6 | MUSTACHE |

Comparing FIG. 6 with FIG. 3, curves M′1 to M′3, which are obtained by the 3^{rd}-degree approximation sine functions are almost equal to curves M1 to M3 defined by the actual measured distortion aberrations. This means that each approximation sine function can calculate a distortion aberration substantially equal to the actual distortion aberration. Similarly, the 3^{rd}- and 6^{th}-degree approximation functions shown in the above formulae (1) and (2) can also calculate a distortion aberration equal to the actual measured distortion aberration. Therefore, when a photograph is taken, the distortion aberration of each image height in the image, namely, for each pixel in the image, can be obtained by an approximation function.

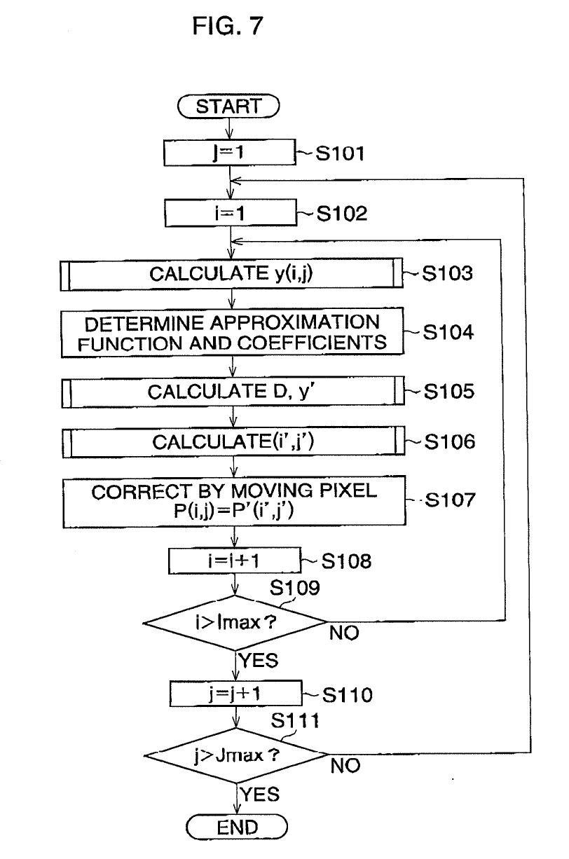

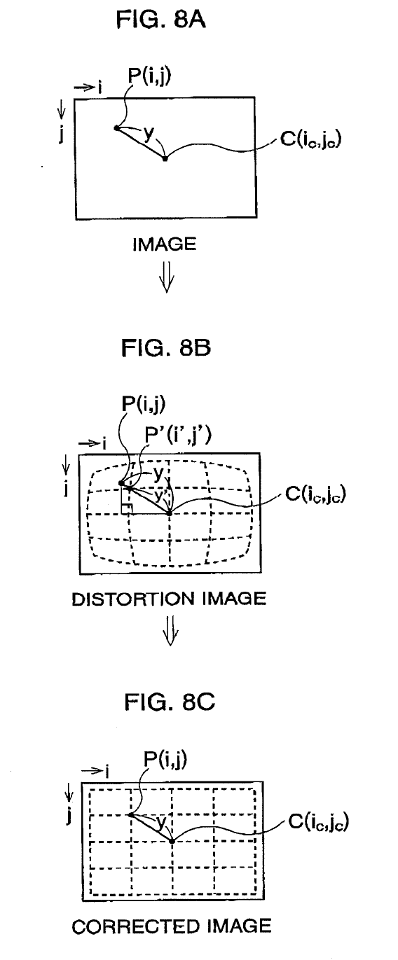

FIG. 7 is a flowchart of the distortion correction process performed by the system control circuit 30. FIGS. 8A to 8C are schematic diagrams showing the correction of image distortion. The distortion correction process is carried out when an image is recorded.

In FIG. 8A, an image to be recorded is shown. The coordinates of each pixel on the image are denoted (i, j). The abscissa is denoted i(1≦i≦Imax), and the ordinate is denoted j(1≦j≦Jmax). The image height of a pixel on an image with distortion is denoted “y′”. On the other hand, the image height of a pixel P to be corrected is denoted “y”. Both the image heights y and y′ indicate a distance from the pixel center point C (i_{c}, j_{c}) to the object pixel P.

In Step S101, i is set to 1, and in Step S102, j is set to 1. Namely, the first pixel P to be processed, (the “object pixel”), is set to the pixel P having the coordinates (1, 1). In Step S103, the value of the image height “y” of the selected pixel P is calculated. The image height y is obtained by calculating the distance between the pixel center point c and the object pixel P.

In Step S104, coefficients of the approximation function, corresponding to the focal length at the photograph, are selected from the series of coefficient data stored in the RAM of the system control circuit 30. Then, an approximation function is defined on the basis of the selected coefficients. Note that, a series of focal length data, which is associated with the positions of the focusing lenses, is stored in the ROM 11 in advance, and when taking a picture, the system control circuit 30 detects the focal length on the basis of the positions of the focusing lenses and the series of focal length data. Herein, we treat the case of barrel distortion (see FIG. 8B), therefore the focal length has the value of a wide angle. Also, the approximation sine function shown in formula (3) is used herein as the approximation function. Therefore, the coefficients of the item to the third power and the angle item to the first power are selected.

In Step S105, the value of the image height y, which is calculated in Step S103, is substituted for the 3^{rd}-degree approximation sine function determined in Step S104. Thus, the distortion aberration D (%) is calculated. Then, based on the calculated distortion aberration D, the image height y′ corresponding to an image with distortion is calculated. The pixel having the imaqe height y′ is denoted “P′”.

In Step S106, the coordinates (i′, j′) of the pixel P′, which are based on the image distortion, are calculated. The pixel r and the pixel P′ have the relationship given in the following formula.

(i−i_{c}):(i−i′)=y:(y−y′)

(j−j_{c}):(j−j′)=y:(y−y′) (7)

Based on the formula (7), the coordinates (i′, j′) of the pixel P′ are obtained. Note that the first, second, third, and fourth quadrants are defined with respect to the original, i.e., the pixel center point C, and the calculation of the coordinates (i′, j′) is carried out in each quadrant.

In Step S107, the coordinates (i′, j′) of the pixel P′ are replaced with the coordinates (i, j) of the pixel P. Namely, pixel information for the pixel P′, i.e., pixel value, is moved to the position of the pixel P, where it belongs. In this manner, the pixel information for pixel P is decided. In other words, pixel P is corrected to compensate for the distortion in the image.

The coordinate i is incremented by 1 (Step S108), and it is determined whether the coordinate i exceeds Imax (Step S109). When it is determined that the coordinate i does not exceed Imax, the process returns to Step S103. On the other hand, when it is determined that the coordinate i exceeds Imax, the coordinate j is incremented by 1 (Step S110), and it is determined whether the coordinate j exceeds Jmax. When the coordinate does not exceeds Jmax, the process returns to Step 8102.

Stops S102 to S109 are repeatedly performed, in which one line's worth of pixels along the abscissa are corrected in order. When all pixels are corrected, the distortion correction process is terminated.

Thus, in the first embodiment, the series of coefficient data associated with approximation functions, which are prepared in each focal length, is stored in the ROM 11 of the lens unit 10A. When the lens unit 10A is attached to the camera body 10B, the series of coefficient data is fed to the camera body ion. Then, when a picture is taken, coefficient data corresponding to a focal length which was determined during the photographing action is selected, so that an approximation function may be determined. The distortion aberration of each pixel is calculated an the basis of the approximation function, and the distortion correction process is carried out by the calculated distortion aberrations.

Since the distortion aberration can be obtained accurately by using the approximation function, the storage of large amounts of plot data for image heights and distortion aberrations is not needed, and the distortion aberration can be calculated rapidly. Also, since only the coefficient data is stored in the ROM 11, the capacity of the ROM 11 may be small, and accurate distortion correction may be carried out with a small amount of data. The amount of coefficient data is particularly small in the case of the 3^{rd}-degree approximation sill function.

Note that an approximation function may be defined in accordance with the characteristics of a lens unit. A function other than the above approximation function, such as a trigonometric function, may be used instead. The distortion correction process may be carried out by a known method other than the method explained above, and exclusive hardware may perform the distortion correction process.

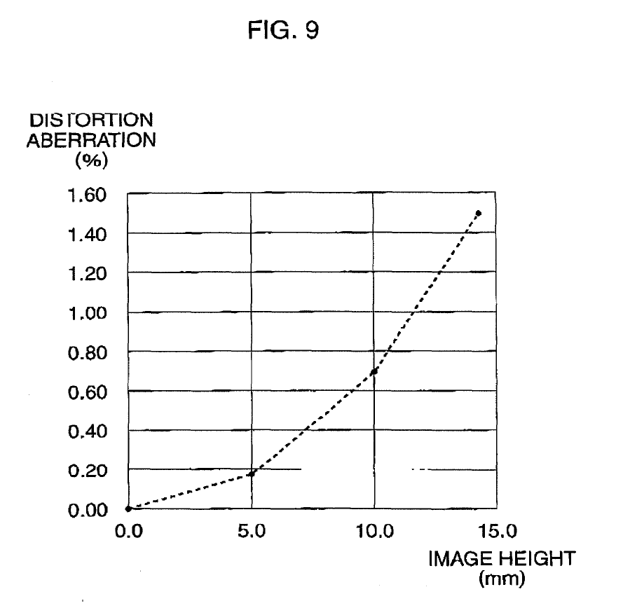

Next, the second embodiment is explained with reference to FIG. 9. The second embodiment is different from the first embodiment in that sample data of image heights and distortion aberrations is stored, and a linear approximation function is obtained. Other constructions are substantially the same as those or the first embodiment.

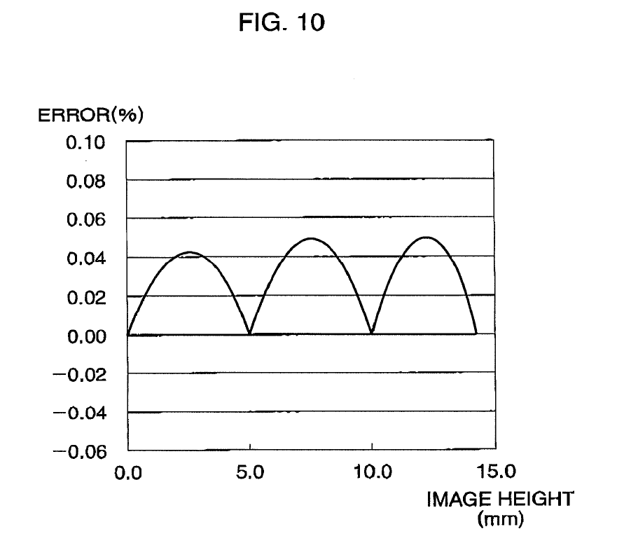

FIG. 9 shows plots of image heights and distortion aberrations, and a linear approximation function. FIG. 10 shows the error generated by the linear approximation function.

In the second embodiment, the number “m” of sample values of image heights and corresponding distortion aberrations is stored in the ROM 11. For example, three sample values of image heights and distortion aberrations as shown in the following table are stored. The sample values are measured in advance at approximately 5 mm intervals, and these sample values are prepared for each focal length.

| | 1 | 2 | 3 |
|---|---|---|---|
| IMAGE HEIGHT (mm) | 5 | 10 | 14.2 |
| DISTORTION | 0.167 | 0.695 | 1.493 |
| ABERRATION (%) | | | |

When a picture is taken, the number “m” of image heights and distortion aberrations is selected according to focal length, and a linear approximation function is defined from plots of the selected sample data. As shown an FIG. 9, the linear approximation function is defined by joining the plots. Based on this linear approximation function, the distortion aberration D is calculated at each image height, i.e., for each pixel. Then, the distortion correction process shown in FIG. 7 is carried out.

As shown in FIG. 10, errors due to the linear approximation function do not exceed 0.6%. This demonstrates that the distortion correction process according to the linear approximation function is accurate and effective. Note that the sample data may be discrete data that can be used to define an approximation function by joining the plots of the discrete data.

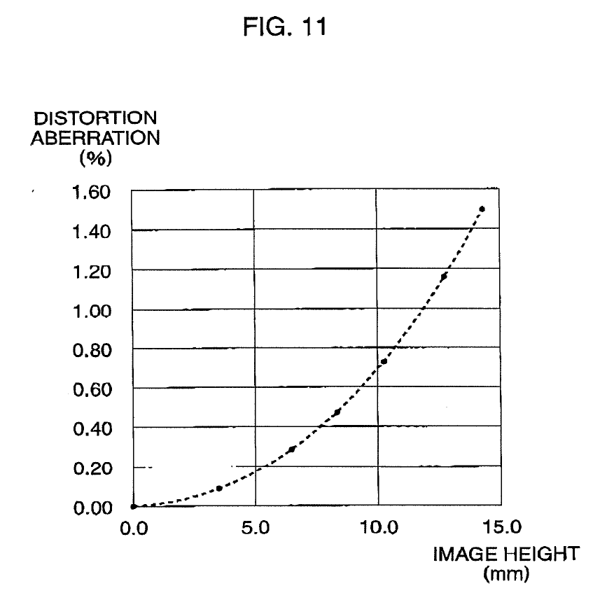

The third embodiment is explained with reference to FIG. 11. The third embodiment is different from the second embodiment in that an approximation polynomial is used.

FIG. 11 is a plot of image height versus distortion aberration, and a 6^{th}-degree approximation polynomial.

When a picture is taken, the number “m” of image heights and distortion aberration is selected according to the detected focal length. Then, based on the selected sample values, coefficients of an approximation polynomial of m−1 degrees are obtained. Note that a method for calculating the number “m−1” of coefficients is generally well known. In FIG. 11, based on seven image heights (including zero) and seven distortion aberrations, the 6^{th}-degree approximation polynomial shown by the broken line is obtained.

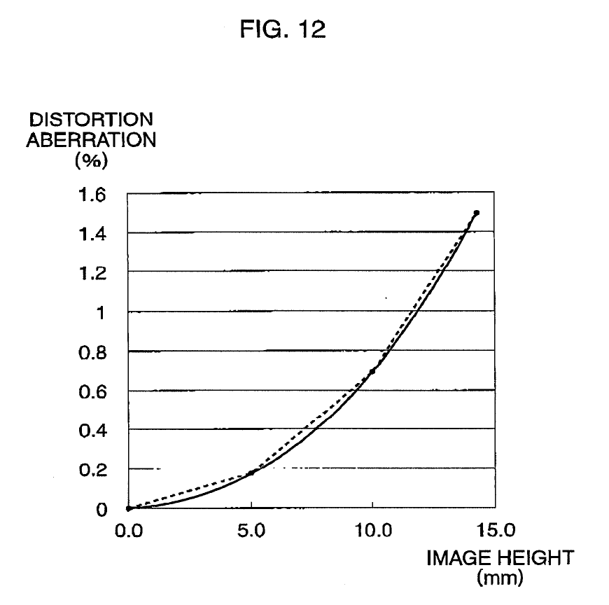

The fourth embodiment is explained with reference to FIG. 12. The fourth embodiment is different from the first embodiment in that a linear approximation function is obtained from an approximation function of n degrees.

FIG. 12 is a view showing an approximation function of 6 degrees an a linear approximation function.

Similarly to the first embodiment, an approximation function of n degrees is obtained from coefficient data of the approximation function of n degrees. Then, a linear approximation function is obtained from the number “m” of coordinate data of the approximation function of n degrees. In FIG. 12, the approximation function or n degrees shown by a solid line and the linear approximation function shown by a broken line are shown.

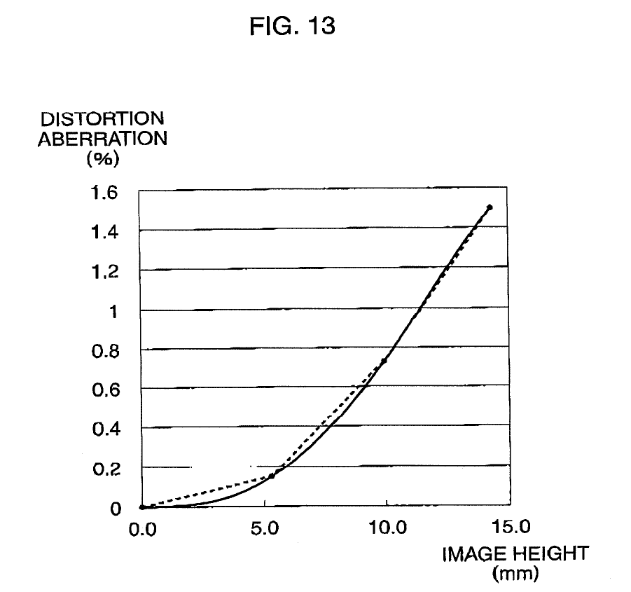

The fifth embodiment is explained with reference to FIG. 13. The fifth embodiment is different from the fourth embodiment in that an approximation sine function is defined.

FIG. 13 is a view showing an approximation sine function and a linear approximation function. An approximation sine function of n degrees is defined from coefficient data of the approximation function of n degrees, and a linear sine function is defined from the number “m” of coordinate data of the sine function of n degrees. In FIG. 13, a 3^{rd}-degree approximation sine function and a linear approximation function are shown.

Note that a compact camera or a cellular phone with camera function may be applied instead of the SLR camera.

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Application No. 2007-091160 (filed on Mar. 30, 2007), which is expressly incorporated herein by reference, in its entirety.

1. A camera comprising:
an interchangeable lens unit removably attached to a camera body;
an image-generating processor that generates image data of a subject captured by said lens unit;
a memory provided in said lens unit that stores distortion data associated with an approximation function that represents a correspondence relationship between image height and distortion aberration, the distortion data comprising at least one of coefficient data of the approximation function, and sample data of the image height and the corresponding distortion aberration;
an approximation function processor that defines an approximation function used for the generated image data on the basis of the distortion data read from said memory; and
a distortion correction processor that carries out distortion correction processing on the image data on the basis of the distortion aberration of each image point that is calculated by the defined approximation function.

2. The camera of claim 1, wherein the distortion data is coefficient data of an approximation function of n degrees, said approximation function processor defining the approximation function of n degrees from the coefficient data.

3. The camera of claim 2, wherein the distortion data is coefficient data of a 6^{th}-degree approximation polynomial.

4. The camera of claim 2, wherein the distortion data is coefficient data of a 3^{rd}-degree approximation polynomial.

5. The camera of claim 2, said approximation function processor further defines a linear approximation function on the basis of the approximation function of n degrees.

6. The camera of claim 2, wherein the distortion data is coefficient data of an approximation trigonometric function of n degrees.

7. The camera of claim 6, wherein the distortion data is coefficient data or an 3^{rd} degree approximation sine function.

8. The camera of claim 6, wherein said approximation function processor further defines a linear approximation function on the basis of the approximation trigonometric function.

9. The camera of claim 1, wherein the distortion data is sample data of image heights and distortion aberrations, said approximation function processor defining a linear approximation function on the basis of the image heights and corresponding distortion aberrations.

10. The camera of claim 1, wherein the distortion data is sample data of the number of image heights and distortion aberrations, said approximation function processor defining an approximation polynomial of m−1 degrees.

11. The camera of claim 1, wherein the distortion data is associated with a series of approximation functions that correspond to a series of focal lengths, said approximation function processor defining an approximation function corresponding to the focal length of a photograph.

12. The camera of claim 11, further comprising a focus adjuster that adjusts the focal length by driving a focusing lens provided in said lens unit, said approximation function processor defining an approximation function in accordance with the focal length based on the position of said focusing lens.

13. An interchangeable lens unit removably attached to a camera body, comprising:
a photographic optical system; and
a memory that stores distortion data associated with an approximation function that represents a correspondence relationship between image height and distortion aberration, the distortion data comprising at least one of coefficient data of the approximation function, and sample data of the image height and the corresponding distortion aberration.

14. A camera body that connects with the interchangeable lens unit recited in claim 13, comprising:
an image-generating processor that generates image data of a subject captured by a lens unit that is removably attached to said camera body;
a data-reading processor that reads the distortion data from said memory provided in said lens unit;
an approximation function processor that defines an approximation function used for the generated image data on the basis of the distortion data; and
a distortion correction processor that carries out distortion correction processing on the image data on the basis of the distortion aberration of each image point that is calculated by the defined approximation function.

15. An apparatus for correcting image distortion comprising;
a data-reading processor that reads distortion data from a memory provided in an interchangeable lens unit, the distortion data being associated with an approximation function that represents the correspondence relationship between image height and distortion aberration, the distortion data being coefficient data of the approximation function or sample data of the image height and the corresponding distortion aberration;
an approximation function processor that defines an approximation function used for an object image, formed by said interchangeable lens unit, on the basis of the distortion data;
a distortion aberration calculator that calculates the distortion aberration each image point by the defined approximation function; and
a distortion correction processor that carries out distortion correction processing on the image data on the basis of the calculated distortion aberration.

16. A computer-readable medium that stores a program for correcting image distortion, comprising:
a data-reading process code segment that brad distortion data from a memory provided in an interchangeable lens unit, the distortion data being associated with an approximation function that represents the correspondence relationship between image height and distortion aberration, the distortion data being coefficient data of the approximation function or sample data of the image height and the corresponding distortion aberration;
an approximation function process code segment that defines an approximation function used for an object image, formed by said interchangeable lens unit, on the basis of the distortion data;
a distortion aberration calculation code segment that calculates the distortion aberration of each image point by the defined approximation function; and
a distortion correction process code segment that carries out distortion correction processing on the image data on the basis of the calculated distortion aberrations.

17. A method for correcting image distortion comprising:
a) reading distortion data from a memory provided in an interchangeable lens unit, the distortion data being associated with an approximation function that represents the correspondence relationship between image height and distortion aberration, the distortion data being coefficient data of the approximation function or sample data of the image height and the corresponding distortion aberration;
b) defining an approximation function used for an object image, formed by said interchangeable lens unit, on the basis of the distortion data;
c) calculating the distortion aberration of each image point by the defined approximation function; and
d) carrying out distortion correction processing on the image data on the basis of the calculated distortion aberration.
